(19) United States
(12) Patent Application Publication
(10) Pub. No.: US 2009/0303192 A1
(43) Pub. Date: Dec. 10, 2009

(54) TOUCH-DRIVEN DEVICES WITH SELECTIVELY ACTIVE REGIONS AND CONTROL METHOD THEREOF

(75) Inventor: MIN-CHING HO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/236,519

(22) Filed: Sep. 24, 2008

(30) Foreign Application Priority Data
Jun. 6, 2008 (CN) 200810302051.4

(51) Int. Cl. G06F 3/041

(52) U.S. Cl. 345/173

(57) ABSTRACT

A method for controlling a touch-driven device including a display is provided. The method includes The method includes providing a display area and a virtual key area for displaying application options, detecting a contacted virtual key, and generating a notification signal in response to the contacted virtual key, retrieving corresponding information of the virtual key if the notification signal represents an adjustment of a dimension of the virtual key area, determining if the notification signal represents an adjustment of a dimension or activation of a power saving function for the display area or the virtual key area, calculating a key area parameter indicating the dimension of the virtual key area, and adjusting the dimension of the virtual key area corresponding to the key area parameter.

### BACKGROUND

1. Field of the Invention

Embodiments of the present disclosure relate to touch-driven devices, and more particularly to a touch-driven device with selectively active regions and a control method thereof.

2. Description of related art

Touch panels are utilized in many electronic devices, providing an improved input means with advantages of convenience and ease of use over typical keypad-style input. Menu selections to access data or activate functions are easily and quickly made.

A typical touch panel includes a sensing unit for detecting and locating contact made with a display panel. When a specific point is contacted, location of the contact is transmitted to a touch panel controller. The touch panel controller analyzes the location of the contact according to a coordinate system, and transmits location coordinates of the contact and/or the associated function of the icon in the contact to a central processing unit (CPU) of an electronic product employing the touch panel.

A typical touch panel may further include an option area and a display area. The option area, functioning similar to a typical keypad, is configured for showing selectable items associated with various functions and/or applications. The display area shows various data, such as images, video, results of user input or other graphically presented information. However, the discrete option and display areas occupy fixed dimensions of the touch panel. In some cases, applications may only require data output to the display area, with no input required, such as video or image display. In such a case, the option area still displays selectable items, wasting both area resources and system power.

Accordingly, what is needed is a touch panel for overcoming the aforementioned problems.

### SUMMARY

A method for controlling a touch-driven device including a display is provided. The method includes providing a display area and a virtual key area for displaying application options, detecting a contacted virtual key, and generating a notification signal in response to the contacted virtual key, retrieving corresponding information of the virtual key if the notification signal represents an adjustment of a dimension of the virtual key area, determining if the notification signal represents an adjustment of a dimension or activation of a power saving function for the display area or the virtual key area, calculating a key area parameter indicating the dimension of the virtual key area, and adjusting the dimension of the virtual key area corresponding to the key area parameter.

Other advantages and novel features of the present touch-driven devices and a control method thereof will become more apparent from the following detailed description of exemplary embodiments when taken in conjunction with the accompanying drawings.

### BRIEF DESCRIPTION OF THE DRAWINGS

FIG. 1 is a schematic diagram of one embodiment of a touch-driven device with selectively active regions used in an electronic apparatus, such as a mobile phone;

FIG. 2 is a schematic block diagram of the touch-driven device of FIG. 1;

FIG. 3 is a schematic diagram of the touch-driven device of FIG. 1, after a plurality of virtual keys are displayed in the virtual key areas; and

FIGS. 4 and 5 are flowcharts illustrating one embodiment of a method for controlling the touch-driven device of FIG. 1.

### DETAILED DESCRIPTION OF CERTAIN INVENTIVE EMBODIMENTS

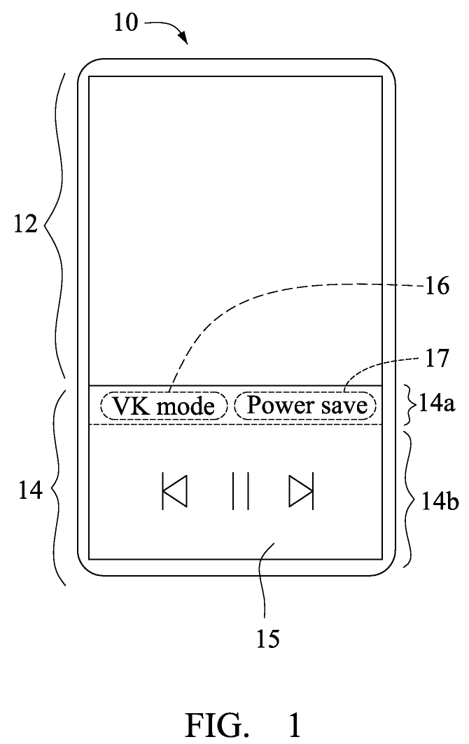

FIG. 1 is a schematic diagram of one embodiment of a touch-driven device 10 with selectively active regions used in an electronic apparatus, such as a mobile phone. Depending on the embodiment, the electronic apparatus may be, a notebook computer, personal digital assistant (PDAs), or other device, without departing from the spirit of the disclosure.

The touch-driven device 10 includes a display providing a display area 12 for displaying various data, such as image, video, results of user input or other graphically-based information, and a virtual key area 14, displaying virtual keys providing control of and access to options of executed applications. For instance, when the mobile phone executes visual media applications, the data is outputted on the display area 12, and the virtual control keys of the visual media application, including “play,” “pause,” “next file,” and “previous file,” are shown in the virtual key area 14. The virtual key area 14 includes a management area 14a and an option area 14b. Each application executed displays a set of virtual control keys in the management area 14a, and a set of basic and advanced virtual keys in the option area 14b.

The virtual control keys provide advanced control of the touch-driven device 10. In the illustrated embodiment, the virtual control keys shown in the management area 14a include a “Virtual key mode” (hereinafter referred to as “VK mode”) option 16 and a “Power save” option 17. In alternative embodiments, additional virtual keys for displaying and/or receiving various input and/or data may be added to the management area 14a.

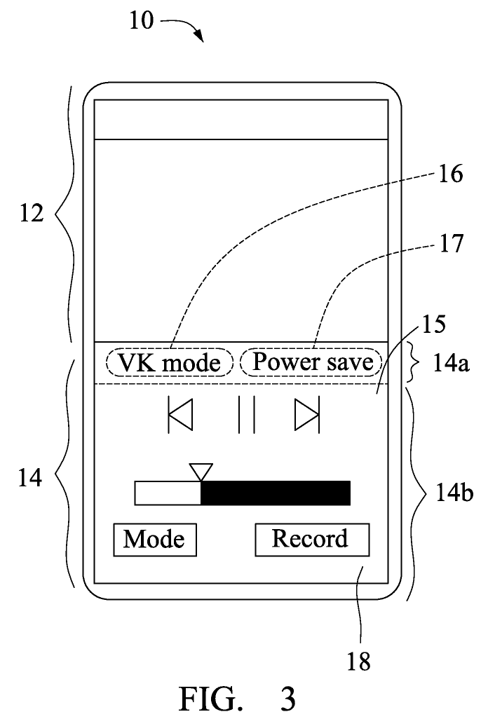

Selection of the “VK mode” option 16 determines if one or more advanced virtual keys will be shown in the option area 14b. In an initial state, the touch-driven device 10 displays only one or more basic virtual keys in the option area 14b as shown in FIG. 1. If the “VK mode” option 16 is selected, one or more advanced virtual keys are added in the option area 14b as shown in FIG. 3. In addition, the one or more advanced virtual keys may be removed from the option area 14b by selecting the “VK mode” option 16 again.

The “Power save” option 17 activates a power saving function for the display area 12 or the virtual key area 14. When the “Power save” option 17 is selected, two options representing respectively “display area 12” and “virtual key area 14” are shown in the option area 14b, allowing power saving function of the respective area to be selectively activated.

In one particular example, the virtual keys may be seldom needed when the display area 12 of the touch-driven device 10 displays a movie. Therefore, power saving function of the virtual key area 14 may be activated to conserve power of the touch-driven device 10. Alternatively, when playing MP3 files (without video output), power saving function can be activated for display area 12.

The basic virtual keys and the advanced virtual key respectively provide basic and advanced operations in relation to the executed applications. For instance, the basic virtual keys of an application for playing MP3 files includes “play,” “pause,” “advance,” and “review.” The advanced virtual keys for the same application may include “volume,” “mode” and “record.”

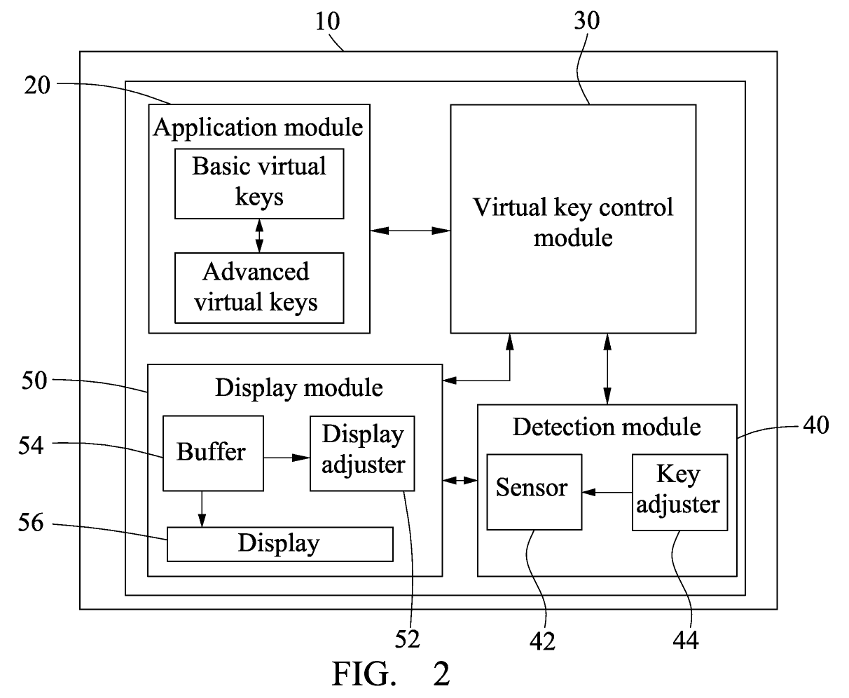

FIG. 2 is a block diagram of the touch-driven device 10. In one embodiment, the touch-driven device 10 includes an application module 20, a virtual key control module 30, a detection module 40, and a display module 50. The modules 20, 30, 40, 50 may be used to execute operations for the touch-driven device 10.

The application module 20 enables configuration of the virtual keys for all applications available in the touch-driven device 10, including the shape, dimensions and corresponding coordinates thereof.

The detection module 40 includes a sensor 42 and a key adjuster 44. The sensor 42 detects contacted virtual keys shown in the management area 14a and the option area 14b. Afterward, the sensor 42 transmits corresponding coordinates of the contacted virtual keys to the key adjuster 44. The key adjuster 44 is configured for determining corresponding operations according to the coordinates of the contacted virtual keys, generating an notification signal indicating the operations, and transmitting the notification signal to the virtual key control module 30.

Upon receiving the notification signal, the virtual key control module 30 determines if the notification signal represents an adjustment of a dimension of the display area 12 or the virtual key area 14, or an activation of a power saving function for display area 12 or the virtual key area 14. The virtual key control module 30 is further configured for retrieving information corresponding to the virtual keys of each application from the application module 20. The information includes coordinates and the corresponding operations of the virtual keys.

If the notification signal represents the “VK mode” option 16, i.e., addition/removal of advanced virtual keys to/from the option area 14b, the virtual key control module 30 calculates key area parameters representing size of the virtual key area 14. The virtual key control module 30 also calculates display area parameters corresponding to the key area parameters. Afterwards, the key area parameters and the display area parameters are transmitted to the detection module 40 and the display module 50.

In addition, upon receiving the key area parameters from the virtual key control module 30, the key adjuster 44 configures corresponding operations of the virtual keys accordingly.

If the notification signal represents the “Power save” option 17, i.e., activating power saving function for the display area 12 or the virtual key area 14, the virtual key control module 30 generates a power save command directing the area to enter power save mode. The power save command is then transmitted to the display module 50.

If the notification signal represents activation of other functions of the basic virtual keys and the advanced basic virtual keys, the virtual key control module 30 executes functions corresponding to the contacted basic and advanced virtual keys.

The display module 50 includes a display adjuster 52, a buffer 54 and a display 56. In the embodiment, the buffer 54 includes two sections for respectively storing data for display in the display area 12 and the virtual key area 14.

The display adjuster 52 is configured for adjusting the dimensions of the sections of the buffer 54 in response to receiving the key area parameters and the display area parameters from the virtual key control module 30. The display adjuster 52 is further configured for determining a power save area in response to receiving the power save command, and transmitting instructions to shut down the operations of the sections corresponding to the power save command. For example, if the power save area is determined to be the display area 12, the display adjuster 52 informs buffer 54, which then shuts down all operations of the sections corresponding to display area 12.

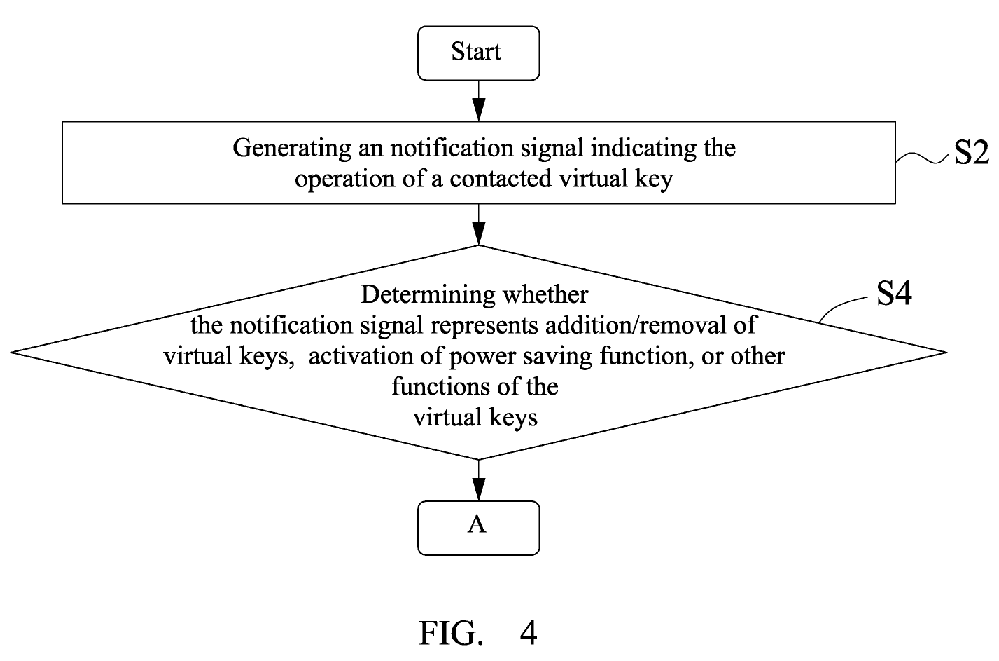

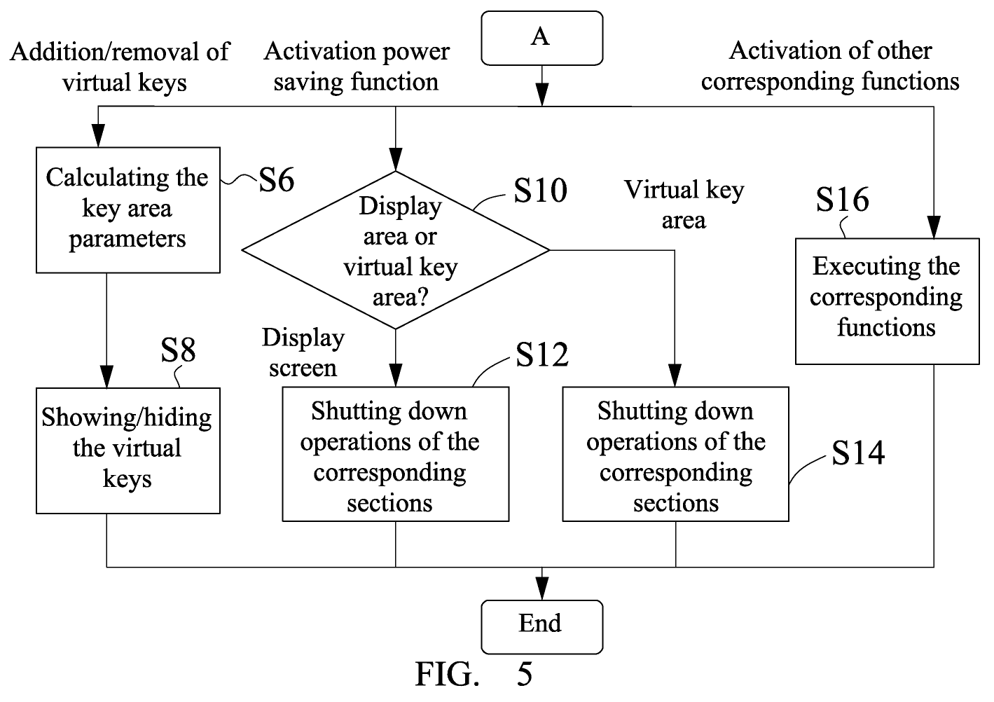

FIGS. 4 and 5 are flowcharts of one embodiment of a method for controlling the touch-driven device 10. Depending on the embodiment, additional blocks may be added or deleted, and the blocks may be executed in a different order than that described without departing from the spirit of the disclosure.

In block S2, the detection module 40 generates a notification signal indicating an operation of a contacted virtual key of the touch-driven device 10. In block S4, the virtual key control module 30 determines if the notification signal represents an addition/removal of one or more virtual keys, activation of power saving function, or other corresponding functions of the basic virtual keys and the advanced virtual keys. If the notification signal represents the addition/removal of virtual keys, in block S6, the virtual key control module 30 calculates the key area parameters indicating the dimensions of the virtual key area 14. In block S8, the display module 50 shows/hides the virtual keys accordingly.

If the notification signal represents the activation of a power saving function for the display area 12 or the virtual key area 14, in block S10, the display module 50 determines an activation of the power saving function for the display area 12 or the virtual key area 14. If power saving function of the display area 12 is activated, in block S12, the display module 50 shuts down operations of the sections of the buffer 54 corresponding to the display area 12. If power saving function of the virtual key area 14 is activated, in block S14, the display module 50 shuts down operations of the sections of the buffer 54 corresponding to the virtual key area 14.

If the notification signal represents an activation of other corresponding functions of the basic virtual keys or the advanced virtual keys, in block S16, the virtual key control module 30 executes the corresponding functions.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A touch-driven device, comprising:
a display for providing a display area and a virtual key area for displaying options and results of executed applications, wherein both the display area and the virtual key area extend along a selected section of the display;
an application module for configuring information for virtual keys for each application installed in the touch-driven device;
a detection module comprising a sensor for detecting a contacted virtual key in the virtual key area, and a key adjuster for generating a notification signal in response to the contacted virtual key;
a virtual key control module for retrieving a corresponding information of the virtual key, determining if the notification signal represents an adjustment of a dimension of the display area or the virtual key area, or activation of a power saving function for the display area or the virtual key area, and generating corresponding parameters and commands according to the notification signal; and
a display module comprising a buffer and a display adjuster for receiving the corresponding parameters and commands, and adjusting the buffer accordingly to change the dimensions of for the display area or the virtual key area or activate the power saving function for the display area or the virtual key area.

2. The system as claimed in claim 1, wherein the virtual key control module is further configured for calculating key area parameters indicating a dimension of the virtual key area if the notification signal represents the adjustment of the dimension of the virtual key area according to the retrieved information of the virtual key.

3. The system as claimed in claim 2, wherein the dimensions of the virtual key area are adjusted when adding or removing virtual keys from the virtual key area.

4. The system as claimed in claim 1, wherein the virtual key control module is further configured for generating a power save command for activating a power saving function for the display area or the virtual key area, and for transmitting the power save command to the display module.

5. The system as claimed in claim 1, wherein the buffer stores data to be displayed in the display area and the virtual key area.

6. The system as claimed in claim 5, wherein the display adjuster is further configured for shutting down operations of sections of the buffer corresponding to the display area or the virtual key area indicated by the power save command.

7. A method for controlling a touch-driven device comprising a display, the method comprising:
providing a display area and a virtual key area for displaying application options;
detecting a contacted virtual key, and generating a notification signal in response to the contacted virtual key;
retrieving corresponding information of the virtual key if the notification signal represents an adjustment of a dimension of the virtual key area;
determining if the notification signal represents an adjustment of a dimension or activation of a power saving function for the display area or the virtual key area;
calculating a key area parameter indicating the dimension of the virtual key area; and
adjusting the dimension of the virtual key area corresponding to the key area parameter.

8. The method as claimed in claim 7, wherein the dimension of the virtual key area is determined to be adjusted when adding or removing virtual keys.

9. The method as claimed in claim 7, further comprising:
generating a power save command for activating power saving function for the display area or the virtual key area if the notification signal represents activation of power saving function for the display screen or the virtual key screen.

10. The method as claimed in claim 9, further comprising:
shutting down operations of sections of a buffer in the touch-driven device corresponding to the display area or the virtual key area indicated by the power save command.
